(19) United States
(12) Patent Application Publication
(10) Pub. No.: US 2007/0168501 A1
(43) Pub. Date: Jul. 19, 2007

(54) Method and system for delivering behavior modification information over a network

(76) Inventors: Nathan Knight Cobb, Jamaica Plain, MA (US); Christian T. Cartter, Cambridge, MA (US); Michael Bukhin, Jamaica Plain, MA (US); Amanda Louise Graham, Washington, DC (US); David L. Rosenbloom, Boston, MA (US); Patricia L. Milner, Charlestown, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/509,986

(22) Filed: Aug. 25, 2006

Related U.S. Application Data
(63) Continuation-in-part of application No. 10/403,167, filed on Mar. 31, 2003.
(60) Provisional application No. 60/368,769, filed on Mar. 29, 2002.
(60) Provisional application No. 60/711,214, filed on Aug. 25, 2005.

(51) Int. Cl. G06F 15/173

(52) U.S. Cl. 709/224

(57) ABSTRACT

This invention features a method of delivering information over one or more information delivery networks, the method including: monitoring the actions of a user on the one or more networks to obtain observed user data relating to a desired behavior modification; obtaining user supplied data relating to the desired behavior modification; evaluating the observed user data and the use supplied data to generate tailored information for progressing a user towards the desired behavior modification; presenting the tailored information to the user over at least one of the networks; and repeating steps a), b), c) and d) until the desired behavior modification is achieved. The user is continually provided with re-tailored information resulting from an iterative process of obtaining and evaluating data that progresses the user towards a desired behavior modification. The desired behavior modification can be, for example, the cessation of smoking.

### RELATED APPLICATIONS

This application is a continuation-in-part of U.S. patent application Ser. No. 10/403,167 filed on Mar. 31, 2003, which claims the benefit of U.S. Provisional Patent Application Ser. No. 60/368,769 filed on Mar. 29, 2002. This application also claims the benefit of U.S. Provisional Application Ser. No. 60/711,214, filed Aug. 25, 2005. All of these applications are incorporated by reference herein.

### FIELD OF THE INVENTION

This invention relates to a method and system for delivering information over a network, and more specifically, a method and system for delivering information about behavior modification over a computer network to a plurality of users.

### BACKGROUND OF THE INVENTION

A major challenge to treating many chronic conditions is modifying established behavior and encouraging compliance with treatment regimens. For example, most people who smoke want to quit but find it very difficult because, in part, the nicotine in tobacco is highly addictive and also because well-established patterns of behavior are difficult to change. This is of great concern because smoking is a major cause of premature death and morbidity in the world. Thus, an intervention that helps large numbers of people quit smoking at reasonable cost and convenience is a major contribution to public health.

Traditional smoking cessation and/or behavior modification programs, which can include written self help materials, personal and/or group counseling and telephone based counseling, typically present static information that is not tailored for specific people and which does not change as a person's circumstances and conditions change during a quit attempt. Clearly, a 40 year old blue collar man who has been smoking for twenty years requires a different behavior modification program than a 20 year old white collar woman who has only been smoking for one year. Static programs can also be disadvantageous because a person may suffer setbacks during a quit attempt. Moreover, a person may not be actively engaged with a behavior modification program and may require encouragement and support from the system and/or other users of the system to progress towards a desired behavior modification.

Persons who wish to quit smoking have traditionally relied on a number of ways to obtain support in quitting. One such method, QuitNet.com, Inc. developed by the same inventors hereof pioneered the online delivery of smoking cessation services with its website, www.quitnet.com, which uses a method of presenting individualized, tailored information to users throughout the various stages of quitting to support and motivate them to the next stage. See co-pending U.S. patent application Ser. No. 10/403,167 entitled “Method and System for Delivering Behavior Modification Information Over a Network” by the same inventors hereof. That method is able to give users the specific information they need, based on data that is constantly collected during their interactions with the website and used to tailor recommendations and relevant content most likely to help the user progress in their efforts to quit smoking. However, that method does not fully integrate other counseling services.

### SUMMARY OF THE INVENTION

It is therefore an object of this invention to provide an information delivery system that obtains user supplied data and also observed user data.

It is a further object of this invention to provide such an information delivery system that provides tailored information to a user based upon the obtained user supplied data and observed user data.

It is a further object of this invention to provide such an information delivery system that repeatedly provides tailored information to a user based upon the obtained user supplied data and observed user data until a desired behavior modification is achieved.

It is a further object of this invention to provide such an information delivery system that integrates other counseling services such as phone counseling, in-person counseling and/or the delivery of printed or electronic materials.

The invention results from the realization that a more effective method for delivering information over one or more information delivery networks, such as the Internet, phone counseling and/or in-person counseling, can be effected by obtaining both user supplied data and observed user data to generate and provide, to a user over the one or more networks, tailored information that progresses the user towards a desired behavior modification. The method can be repeated until the desired behavior modification is achieved. The desired behavior modification may be, for example, the cessation of smoking.

The subject invention is directed to a method of online program management and integration that enables smoking cessation counselors to enroll, manage, and support users who are trying to quit smoking by giving them a comprehensive and customized quitting program. Examples of program modules that can be combined include a custom version of the website to provide 24/7 web-based support include pro-active phone counseling, in-person counseling, or a printed quitting guide. The users' interaction with the system is tracked comprehensively, and online components, such as web support and alerts delivered via email or to wireless devices, may be used in all treatment modalities, wherever the patient expresses a preference for it. Data collected through patient and counselor interaction in all modalities is recorded and reported in a comprehensive database so that those interacting with the system can evaluate and improve the system to deliver the most effective combination of support services for each user.

Because care givers across treatment modalities can access the patient's smoking and quitting history record stored in a central web-accessible database, patient care is coordinated in real-time, having a direct effect on quality of care. The patient can interact with the data system via the website where they contribute information directly via self-assessments and indirectly via feature utilization tracking. The patient also updates their personal data through contact with a counselor who has access to the system via Web-accessible interfaces and is authorized by the patient to make updates. If, for example, a key quit smoking data point, such as the patient's quit date or medication plan, is changed by the patient directly on the website, or by a phone counselor in conversation with the patient, key automated and personalized support services can be reset in real-time so that on-going care, delivered over various networks, are more effective. Real-time alerts, whether of upcoming counseling appointments or time-appropriate quitting or medication tips, are more accurate and relevant. Non-automated support services, such as those supplied by in-person and web counselors, are also improved through access to up to the minute information.

The ability to coordinate the different modalities of treatment delivers a greater benefit than the individual parts and allows the method employed on the website to tailor information specific to the user's needs to be applied in other modalities of treatment. Additionally as all information related to the user's interaction with the system in any modality is collected, a comprehensive support system can be administered in a customized, tailored fashion.

The invention features a method of delivering information over one or more information delivery networks, the method including a) monitoring the actions of a user on the one or more networks to obtain observed user data relating to a desired behavior modification, b) obtaining user supplied data relating to the desired behavior modification, c) evaluating the observed user data and the use supplied data to generate tailored information for progressing a user towards the desired behavior modification, d) presenting the tailored information to the user over at least one of the networks, and e) repeating steps a), b), c) and d) until the desired behavior modification is achieved

In a preferred embodiment the one or more information delivery networks may includes the Internet. The one or more information delivery networks may include a network chosen from the group consisting of a telephone network, an email communication network, interpersonal communication with a counselor, and a postal mail network. The tailored information may include print or electronic media. The desired behavior modification may include the cessation of smoking. The method may further include the step of determining if additional data is required from the user in order for the user to achieve the desired behavior modification. The method may further include the step of obtaining the additional data from the user. The user action may be selected from the group consisting of: an interaction with a online questionnaire, an interaction with a module to assist the user in the cessation of smoking, an interaction with a module to assist the user in selecting a date for the cessation of smoking, interacting with a module to provide the user with the ability to manage personal information, an interaction with a calendar module to provide the user with the ability to set dates and goals which relate to the quit date and the desired behavior modification, an interaction with a journal module that allows the user to record information related to the desired behavior modification, an interaction with a Medications Module, an interaction with a module relating to frequently asked questions, and an interaction with an online support community, and an interaction with one or more of a telephone network, an email communication network, interpersonal communication with a counselor and a postal mail network. The Medications Module may suggest a medication profile to the user based upon user observed data and the user supplied data. The action of the user may include an interaction with an online support community that may be selected from the group consisting of: a discussion forum relating to discussion of specific issues associated with the desired behavior modification, a user initiated forum, interactive communication with community members via on-line chat, a buddy feature that tracks whether other known users are on-line at the same time as the user, a list of users who are celebrating a milestone in the desired behavior modification, e-mail for sending and receiving messages to and from others users on the system, and one or more of a telephone network, an email communication network, interpersonal communication with a counselor and a postal mail network. The user supplied data may be selected from the group consisting of: a quit date, an age, a sex, a zip code, a type of dependency, a quantity of dependent substance used, and questionnaire answers. The user observed data may include how often the user has interacted with specific features. The method may further include the step of providing a link to the user to enable the user to interact with a counselor over the one or more delivery networks. The method may further include the step of providing the observed user data and the user supplied data over the one or more networks to the counselor such that the counselor can provide tailored information and suggestions to the user based upon the observed user data and the user supplied data.

This invention also features a method of delivering information over one or more information delivery networks, the method including a) monitoring the actions of a user on the one or more networks to obtain observed user data relating to a cessation of smoking, b) obtaining user supplied data relating to the cessation of smoking, c) evaluating the observed user data and the use supplied data to generate tailored information and provide suggestions for an event, the tailored information and suggestions for progressing a user towards the cessation of smoking, d) presenting the tailored information and suggestions to the user over at least one of the networks, and e) repeating steps a), b), c) and d) until the cessation of smoking is achieved.

This invention also features a system for delivering healthcare content to a user over a one or more information delivery networks, the system including an Internet support module for providing counseling support to the user over the Internet, the Internet support module including a monitoring engine for monitoring an event of a user on the network to obtain observed user data relating to the cessation of smoking, and to obtain user supplied data relating to the cessation of smoking and an evaluation engine responsive to the monitoring engine, the evaluation engine configured to evaluate the observed user data and the user supplied data to generate tailored information which progresses the user towards the cessation of smoking. A telephone counseling module for providing counseling support to the user over the telephone.

In a preferred embodiment the system may further include an in-person counseling module for providing counseling support to the user. The system may further include a quitting guide module for providing print media delivered to the user electronically or via postal mail. The system may further include a medications module for suggesting a medication to the user. The system may further include a Quit Date Module for assisting the user in selecting a quit date for the desired behavior modification program. The system may further include a Profile Module for providing the user with the ability to manage personal information.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic diagram of an example of the information delivery service according to the subject invention;

FIG. 2 is a schematic diagram of the server of FIG. 1 in greater detail;

FIG. 3 is a flowchart of one method for delivering information that can be used with the server of FIG. 1;

FIG. 4 is the flowchart of FIG. 3 in greater detail showing the monitoring engine, evaluation engine, and presentation engine;

FIGS. 5A and 5B are diagrams of an exemplary behavior modification program that can be used with the system of FIG. 1;

FIG. 6 is a flowchart for a Quitting Guide Module that is used with the system of FIG. 1;

FIG. 7 is a flowchart for a Quit Tips Module that is used with the system of FIG. 1;

FIG. 8 is a flowchart for a My Quit Module used with the system of FIG. 1;

FIG. 9 is a flowchart for a My Next Steps Module that is used with the system of FIG. 1;

FIG. 10 is a flowchart for a Medications Module that is used with the system of FIG. 1;

FIG. 11 is another flowchart of the Medications Module of FIG. 10;

FIG. 12 is a schematic diagram of a web page structure that is used with the system of FIG. 1;

FIG. 13 is a software interface that is used with the server of FIG. 1;

FIG. 14 is another software interface that is used with the server of FIG. 1;

FIG. 15 is a diagram of an e-mail sent to a user from the server of FIG. 1; and

FIG. 16 is a schematic block diagram of another embodiment of the information delivers service shown in FIG. 1 that includes phone counseling, in-person counseling and the delivery of printed or electronic materials of this invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

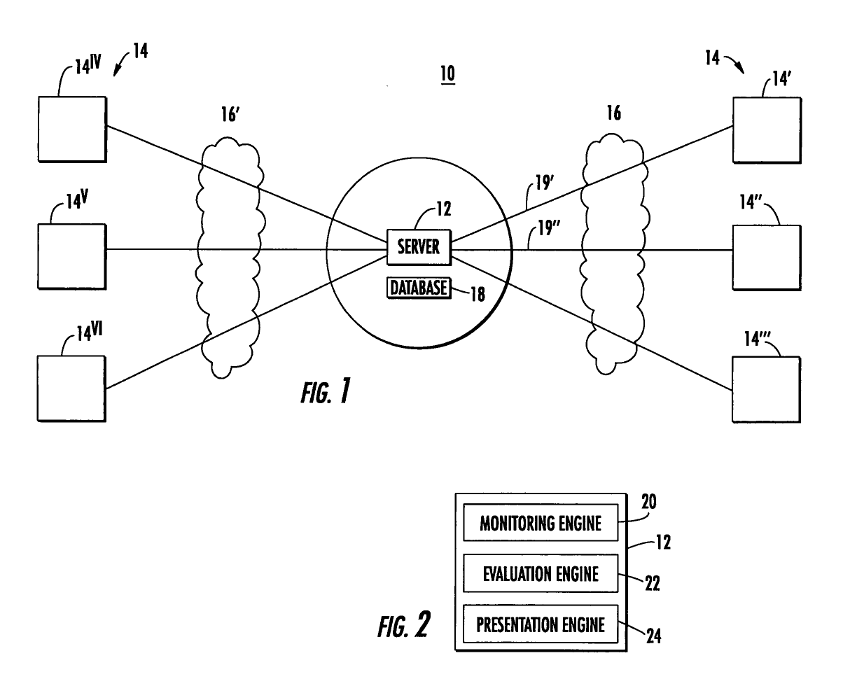

There is shown in FIG. 1 an information delivery system 10 which includes a server 12, one or more user terminals 14, and computer networks 16 and 16′. User terminals 14 can include one or more remote or local terminals 14′, 14″, and 14′″, . . . , each of which can be any apparatus that can connect to server 12 through network 16 or 16′, such as a computer, computer terminal, cell phone, personal digital assistant (PDA), tablet PC, mobile phone, a programmable user interface, or any apparatus with a web browser. Networks 16 and 16′ can include any type of computer network such as a local area network, a wide area network or the Internet. Server 12 includes at least one database that stores information for distribution through or use on server 12.

In operation, a user 14′ can connect to server 12 through network 16 over line 19′ to obtain or provide information, which can relate to a desired behavior modification. Also, user 14′ can connect to server 12 and communicate with another user 14″ to exchange information that will lead towards a desired behavior modification.

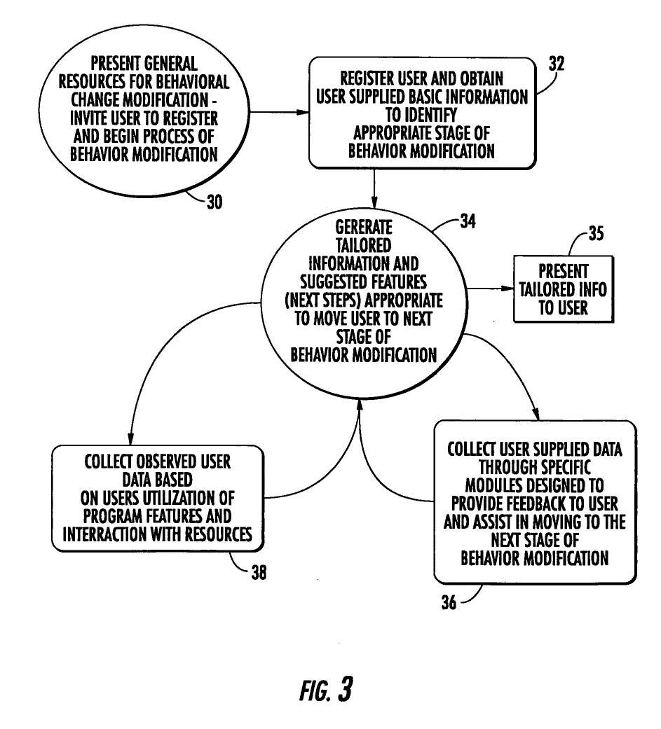

Server 12, FIG. 2, preferably includes a monitoring engine 20, evaluation engine 22, and presentation engine 24. Monitoring engine 20 monitors an action of one of the users 14′, FIG. 1, over network 16 to obtain information that monitoring engine 20 observes about the user. Specifically, monitoring engine 20 observes the actions of one of the users on the network to obtain observed user data that relates to the desired behavior modification. In addition, monitoring engine 20 also monitors the actions of the user on the network to obtain user supplied data relating to the desired behavior modification. To obtain the user supplied data, monitoring engine 20 may merely accept the data that the user supplies to server 12 over network 16. Evaluation engine 22 obtains from monitoring engine 20 the observed user data and the user supplied data to generate information tailored to a specific user. For example, evaluation engine 22 can provide a suggestion for a user to try another program or event on server 12.

Additionally, evaluation engine 22 can provide tailored information to the user that will progress the user towards desired behavior modification, such as providing an appropriate level of information to the user. Presentation engine 24 takes the information produced by evaluation engine 22 and presents the tailored information and any suggestions to the user over network 16. Server 12 can iteratively repeat the actions of monitoring engine 20, evaluation engine 22, and presentation engine 24 until the desired behavior modification is achieved.

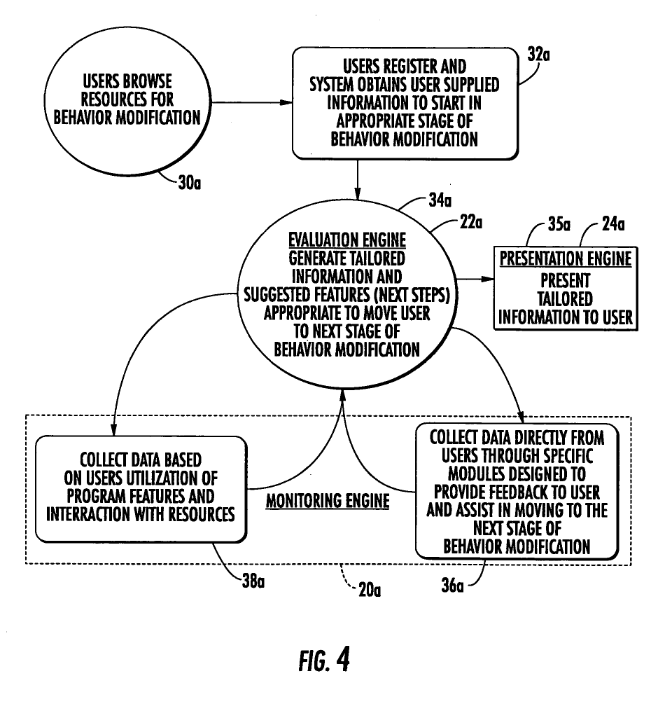

The flowchart of FIG. 3, which depicts the primary steps associated with delivering information over a network, begins at 30 with presenting information about a behavior modification over a network. This presentation of information can invite the user to register with a service associated with server 12 and begin using the service. At step 32, the server registers the user and obtains basic registration information to identify at the user's current stage of behavior modification. Based upon the user supplied data obtained in step 32, the server uniquely displays tailored information and/or suggestions to the user that will progress the user towards the desired behavior modification. In step 35, the server presents the tailored information generated in step 34 to the user over the network. In step 36, the server collects user supplied data provided by the user through specific software modules. These software modules can provide informative feedback to the user and assist the user in progressing towards the next stage of behavior modification. In step 34, the server takes the user supplied data obtained in step 36 to regenerate the tailored information and suggested features appropriate to move the user to the next stage of behavior modification. In step 35, the regenerated tailored information is presented to the user. In this manner, the user is continually provided with re-tailored information resulting from an iterative process of obtaining and evaluating data that progresses the user towards a desired behavior modification.

In step 38, the server observes the user's action over the network and collects the observed user data. For example, the server can observe the user's utilization of program features and interaction with informational resources on the server. At 34, the server regenerates the tailored information and/or the suggested features and in step 35 presents the regenerated tailored information to the user. Steps 36 and 38 can be individually repeated in conjunction with step 34 as much as necessary, or as much as desired, to generate up-to-date tailored information based upon the user's current stage of behavior modification. Likewise, steps 34, 36 and 38 can occur in any order. The step of presenting the tailored information to the user in step 35 can be done as often as desired so as to present the user with updated tailored information and/or suggestions.

In a more specific embodiment of FIG. 3, as shown in FIG. 4, where like parts have been given like numbers accompanied by a lower-case “a”, the step of generating tailored information and suggested features is performed by evaluation engine 22a. The steps of 36a and 38a are performed by monitoring engine 20a. One or more monitoring engines could be used to collect the observed user data at 38a and the user supplied data collected in step 36a. The step of presenting the tailored and re-tailored information to the user is performed by presentation engine 24a.

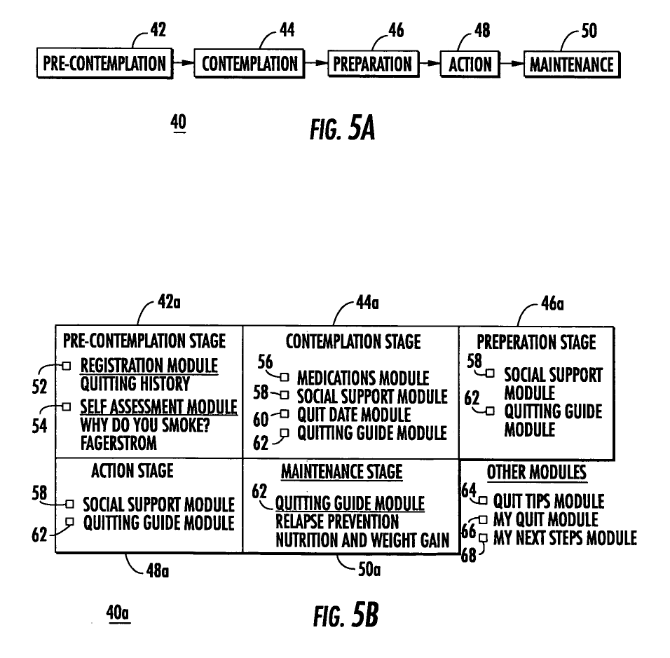

An exemplary behavior modification program 40, FIG. 5A, includes five stages 42-50 for modifying behavior. These stages include Pre-contemplation Stage 42, Contemplation Stage 44, Preparation Stage 46, Action Stage 48, and Maintenance Stage 50. Program 40a, FIG. 5B, specifically relates to a smoking cessation program. Each of stages 42a-50a can include one or more modules or programs that progress a user towards the next stage of the program. Each of the modules in program 40a can be used with only one of stages 42a-50a or with several of the stages. Although FIGS. 5A and 5B show a behavior modification program having a number of stages, the subject invention is not limited to a behavior modification program or a behavior modification program having stages.

Pre-contemplation Stage 42a includes a Registration Module 52 and a Self-Assessment Module 54. Registration Module 52 obtains information about a user's quitting history, age, sex, zip code, type and quantity of dependency, and other user information that may be necessary for demographics, etc. Self-Assessment Module 54 can include questionnaires to assist the user in assessing their stage of modification such as a “Why do you smoke?” questionnaire and a Fagerström questionnaire, which is well known in the art of smoking cessation.

Contemplation Stage 44a includes a Medications Module 56, a Social Support Module 58, a Quit Date Module 60, and a Quitting Guide Module 62. Medications Module 56 evaluates a user's response to a detailed questionnaire and displays a recommendation of medication tailored to the user's needs.

Social Support Module 58 allows users 14 to participate in a network support community. For example, Social Support Module 58 allows users to identify themselves to other users, engage in private communications through e-mail or other means, report problems and abuses to the server, and obtain a sense of history in their interactions with the server or website. Some of the features that can be implemented with Social Support Module 58 include discussion forums designated for discussion of specific issues associated with the behavior modification, clubs, such as user-initiated discussion forums, a chat feature to provide live, interactive communication with community members, Q-mail to facilitate private user-to-user communications that do not require users to reveal their e-mail addresses, a buddies feature that allows users to track whether other users they know are on the network at the same time, a list of users who are celebrating a milestone in their desired behavior, a user directory which allows users to locate other members with similar profile characteristics, and/or an anniversaries feature which lists users who are celebrating particular milestones in their process of behavior modification.

Quit Date Module 60 assists a user in setting a particular goal date for a behavior modification, such as the cessation of smoking. If the behavior modification is cessation of smoking, setting the quit date is an action that starts a user to plan a program of quitting. For other behavior modifications, this module would assist a user in setting other time-based goals. If a user has not set a quit date, Quit Date Module 60 suggests to the user that the user set a quit date. To ensure that the user supplied quit date is still accurate, Quit Date Module 60 can prompt the user at a re-occurring predetermined time interval, asking whether the quit date is still accurate.

Quitting Guide Module 62 displays tailored information that depends upon the user supplied data and the user observed data. The tailored information generally relates to how a user can progress towards the next stage of behavior modification. One manner in which the information from Quitting Guide Module 62 is tailored is that the information is divided into sections relating to the different stages 42-50 of behavior modification. For example, for a user who is early in the process of behavior modification and has not set a quit date, Quitting Guide Module 62 can display a chapter heading such as “Making the Decision” to the user since the user is at Pre-contemplation Stage 42. Once the user sets a quit date and progresses to Contemplation Stage 44, Quitting Guide Module 62 will display one or more chapters of information relevant to stage 44. The information that Quitting Guide Module 62 provides to a user can be further tailored in that the actual text provided by the guide is tailored depending upon the user's characteristics. For example, a pregnant woman who reads information from a guide will see additional paragraphs relevant to her pregnancy. Thus, Quitting Guide Module 62 evaluates both the state of behavioral change of the user and any other data from monitoring engine 20a to generate specific advice.

Preparation Stage 46a includes Social Support Module 58 and Quitting Guide Module 62. Although modules 58 and 62 are included in both stages 44 and 46, modules 58 and 62 may provide and obtain different sets of information depending on which stage the user is at. Action Stage 48a also includes Social Support Module 58 and Quitting Guide Module 62. Maintenance Stage 50a includes Quitting Guide Module 62 which can include information relevant to Maintenance Stage 50a, such as relapse prevention, and nutrition and weight gain. Behavior modification program 40a can also include other modules that are used with one or more of stages 42a-50a, such as a Quit Tips Module 64, a My Quit Module 66, and a My Next Steps Module 68.

Quit Tips Module 64 schedules processes that offer users additional recommendations whether or not they access the information on server 12. At a predetermined frequency, such as daily, the server determines which users have subscribed to a service on the server. The server can then evaluate all available data about each of the users and personalize a message in the form of an e-mail, such as an HTML e-mail. For example, if the server determines that the user has selected a medication plan, the e-mail will include a section that has specific medication tips. The information in these e-mails can be based upon the user's stage of behavior modification in addition to all monitored data.

My Quit Module 66 serves as a functional wrapper to several of the other modules on the server. In the embodiment in which the server provides a website to users, My Quit Module 66 is the personal log in and resource center for individuals working to quit smoking. When a user logs into the web page on the server, My Quit Module 66 evaluates all existing data that the user has supplied and combines this with data that has been observed about the user's activity on the website. This combined information is used to target the sub-modules of information on the web page and to tailor information on the page for the user. My Next Steps Module 68 suggests one or more actions a user should complete next to progress towards the desired behavior modification. For example, My Next Steps Module 68 can provide a list of prioritized features available on the server or website that the user should complete.

A user's stage of behavior modification will influence what features or modules are more useful or relevant, and, thus, will influence what features or modules My Next Steps Module 68 will suggest to a user. For example, a user in Action Stage 48 will benefit more from features like buddies and the journal because the user can find other users for support and to record process. My Next Steps Module 68 may direct a user who is in Contemplation Stage 44 to features like forums and chat. My Next Steps Module 68 takes into account actions that a user has already taken or completed. For example, a user may have already used the buddies feature, so My Next Steps Module may now recommend that feature to the user and may recommend another feature that the user has not recently used.

My Next Steps Module 68 makes suggestions to users in two different manners. First, My Next Steps Module 68 will display all the different features available to the user and graphically display which features the user has already tried, such as by turning a hypertext link to a different color. Second, My Next Steps Module 68 will suggest to the user the top three relevant features that the user should try next based upon the data the server has evaluated about the user.

My Next Steps Module 68 can use an algorithm to determine what features to suggest to a user. One such algorithm is a search engine that uses a matrix of available features that have a desirability score appropriate for the user's stage of behavior modification. The matrix can also designate that some features are excluded for some users or for users in a particular stage of behavior modification. The matrix can include the number of times if any a user has used each feature and use this information to determine what feature(s) should or should not be suggested to a user. As a user continues to use the behavior modification program 40a and the server gathers more data about the user, My Next Steps Module 68 can more accurately target suggested features to a user based upon the user's background data.

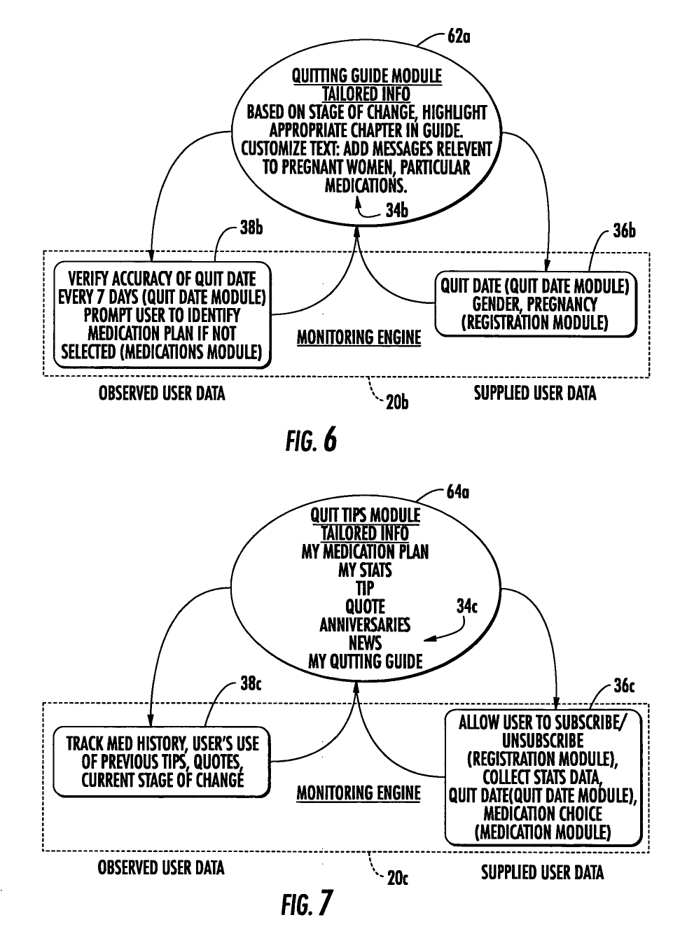

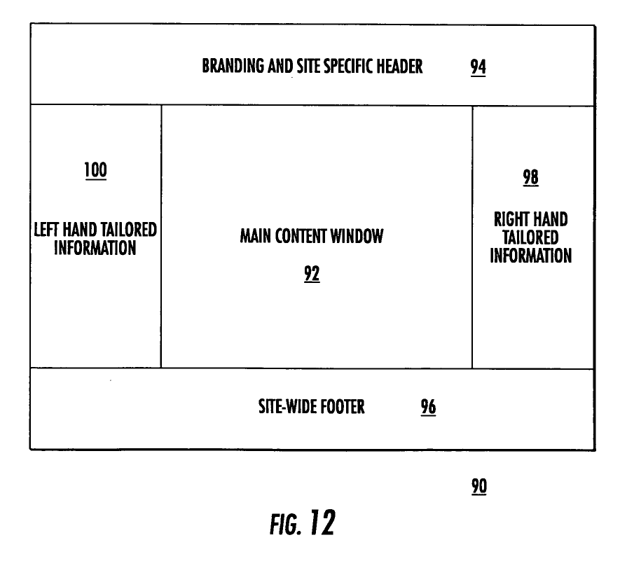

FIGS. 6-10 show five different modules used with program 40a and the data that each module monitors to create tailored information for each user. Quitting Guide Module 62a, FIG. 6, obtains user supplied data 36b from various modules such as the Quit Date Module or the user's gender or pregnancy information from the Registration Module. Quitting Guide Module 62a also obtains observed user data 38b, such as monitoring whether or not a user has selected a medication plan or has recently verified the accuracy of the user's quit date. Quitting Guide Module 62a uses the user supplied data 36b and the observed user data 38b to create tailored information 34b such as highlighting an appropriate chapter and an informational guide, customizing text, adding messages relevant to pregnancy if a user is pregnant, and providing information about particular medications.

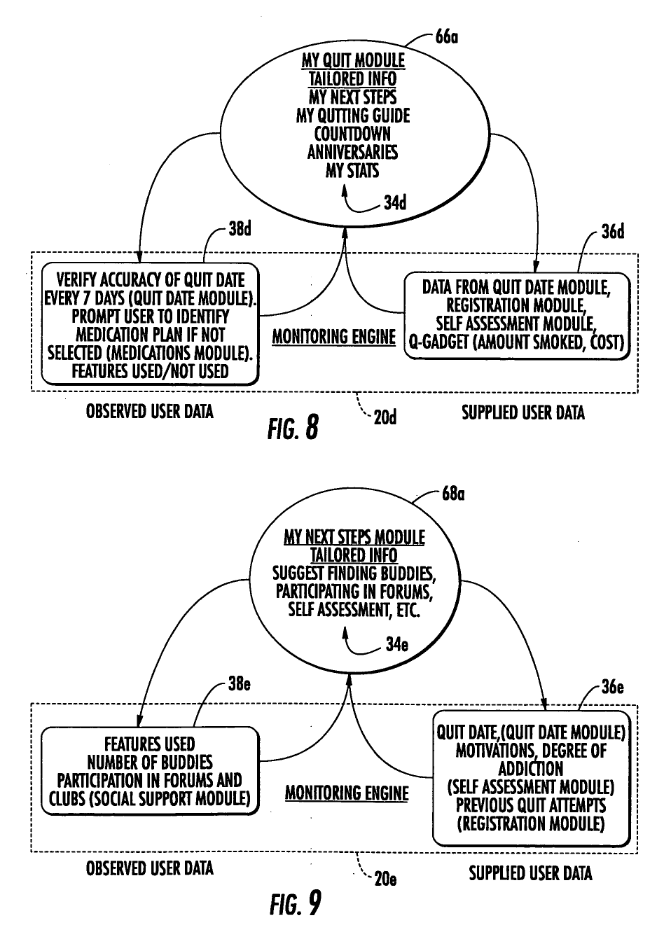

Quit Tips Module 64a, FIG. 7, obtains user supplied data 36c, such as subscription information obtained from the Registration Module, quit date information obtained from the Quit Date Module and medication choice obtained from the Medications Module. Quit Tips Module 64a obtains observed user data 38c such as data relating to the user's use of prior Quit Tips e-mails, the user's navigation on the server or website, the user's use of tips or quotes, and the observed user's current stage of behavior modification. Quit Tips Module 64a provides tailored information 34c to the user, such as a tailored medication plan, statistics, tips, quotes, anniversaries, news, or tailored information from the My Quitting Guide Module.

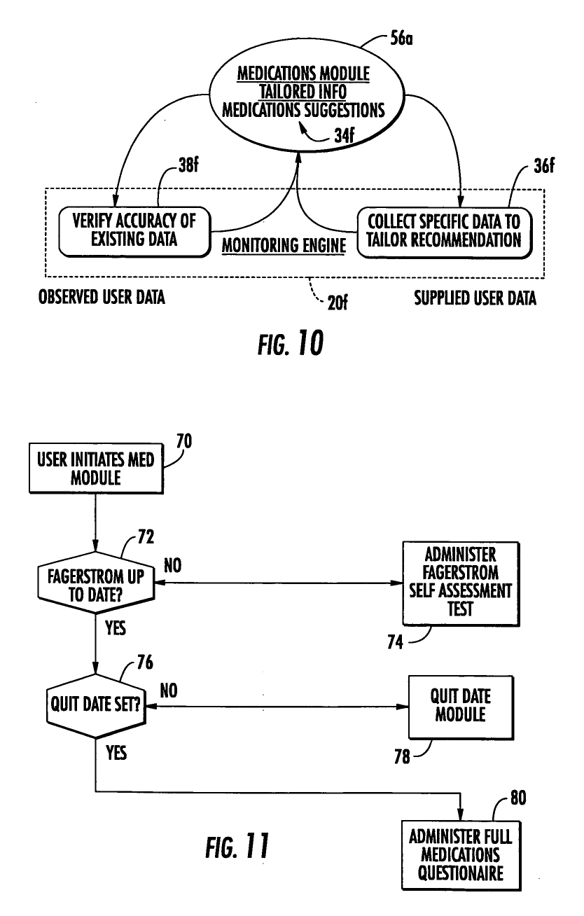

My Quit Module 66a, FIG. 8, obtains user supplied data 36d, such as user information from the Registration Module, user information from the Self-Assessment Module, and user smoking history obtained from a Q-gadget feature. The Q-gadget feature collects data from the user, such as how frequently the user smokes and the user's cost of smoking, to calculate smoking statistics for the user. After setting a quit date, a user can access the Q-gadget feature and change the user's smoking information such as the cost per pack and cigarettes smoked per day. In response to the changed user information, the Q-gadget feature changes the user's statistics, such as the lifetime saved, money saved, etc.

My Quit Module 66a obtains observed user data 38d, such as whether or not the user has verified the accuracy of the quit date from the Quit Date Module, whether or not the user has selected a medication plan from the Medications Module, and what features the user has used and has not used. My Quit Module 66a uses data 36d and 38d to provide tailored information 34d, such as tailored information for the My Next Steps Module or the Quitting Guide Module, a tailored countdown, anniversary or statistics.

My Next Steps Module 68a obtains user supplied data 36e, such as a quit date from the Quit Date Module, smoking motivations or degree of addiction from the Self-Assessment Module, or previous quit attempts from the Registration Module. My Next Steps Module 68a obtains observed user data 38e, such as features that the user has not used on the server, the number of buddies, or the amount of participation in forums or clubs from the Social Support Module. My Next Steps Module 68a uses data 36e and 38e to provide tailored information 34e, such as suggesting the user find buddies on line, participating in forums, or performing a self-assessment.

Medications Module 56a obtains user supplied data 36f, such as specific data to tailor a medication recommendation. Medications Module 56a obtains observed user data 38f, such as by verifying the accuracy of existing data, or observing the user's activity on the server with respect to medications. Medications Module 56a, uses the tailored information 34f to provide suggestions about types of medication and suggestions for taking a specific medication. It should be apparent from the above description for FIGS. 6-10 that any module can obtain user supplied data and/or observed user data from any of the other modules described herein and also from the user's activity on the server or website.

A flowchart, FIG. 11, for using the Medications Module begins in step 70 with allowing the user to access the Medications Module. In step 72, the Medications Module determines whether or not the information relating to the Fagerström self-assessment test is up-to-date. If the test information is not up-to-date, in step 74, the Medications Module administers either part of the Fagerström test, or the full test. If at step 72, the Medications Module determines that the Fagerström information is up-to-date, then in step 76, the Medications Module determines whether or not the user has set a quit date for the behavior modification, such as the cessation of smoking. If the user has not set a quit date, then in step 78 the Quit Date Module assists the user in setting a quit date. The Medications Module may either automatically send the user to the Quit Date Module, or may only suggest that the user access the feature associated with the Quit Date Module to set a quit date. If at step 76 the Medications Module determines the user has set a quit date, at step 80, the Medications Module administers a full medications questionnaire to determine what is the best medication for a user to progress towards the behavior modification, such as the cessation of smoking.

Software interface 90, FIG. 12, includes the main content window 92, a site specific header 94, site-wide footer 96, right-hand tailored information 98, and left-hand tailored information 100. Main content window 92 displays information depending on what feature or part of the server site, such as a website, that the user is looking at. Site specific header 94 includes typical information that may be included on every web page and can also include branding information to identify a specific network or website. Right-hand 98 and Left-hand 100 tailored information includes information that the server has determined is appropriately tailored to each specific user. Site-wide footer 96 can include a standard footer on each network or website, such as a copyright notice and/or site-specific information. This tailored and re-tailored information may be different for every user that accesses the information on the server.

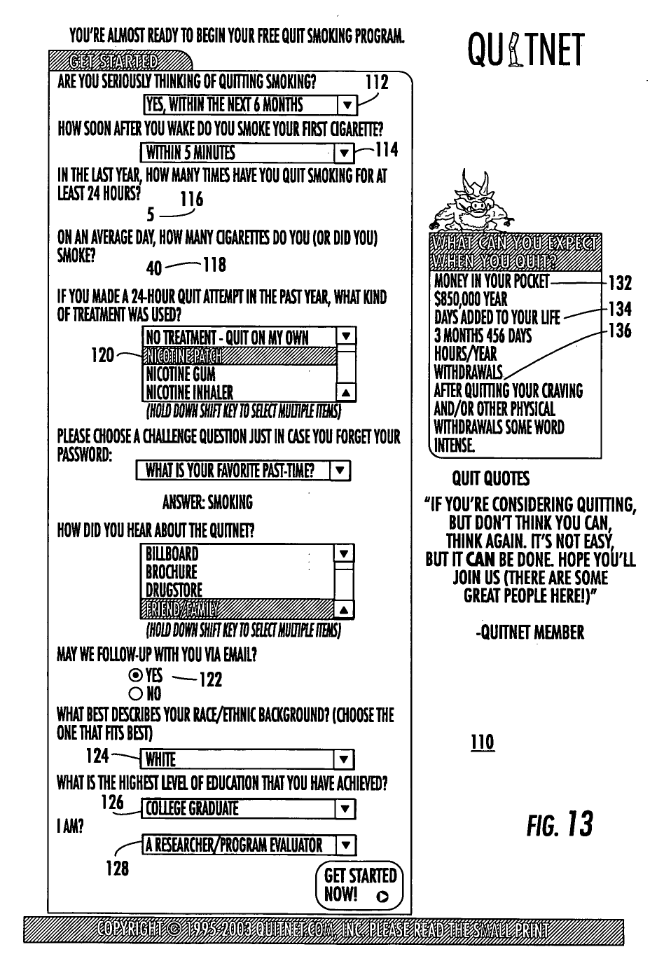

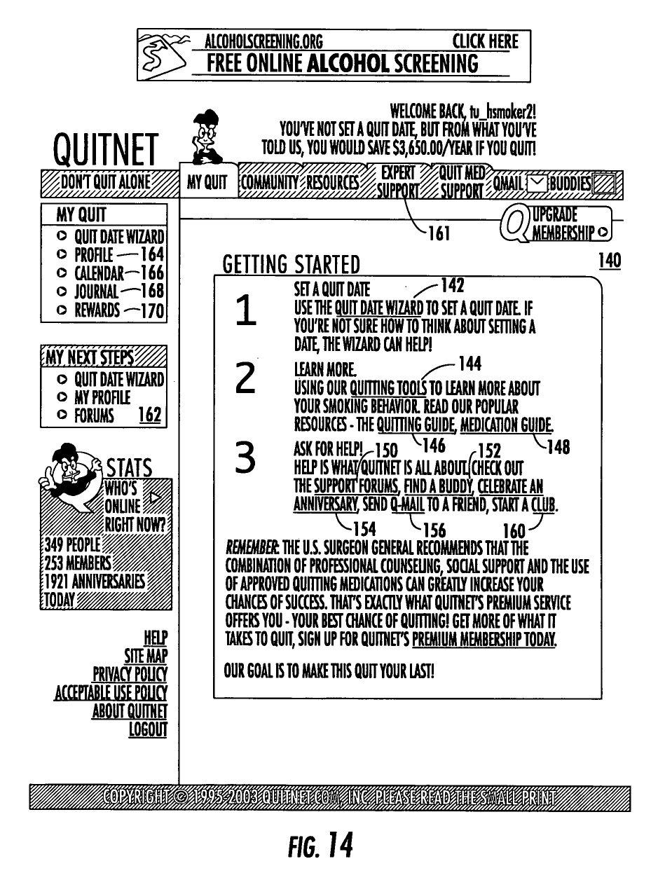

Software interface 110, FIG. 13, shows how the server can obtain user supplied information and provide tailored information to the user. To obtain user supplied information, the server can provide registration questions to the user. For example, the server can obtain information about whether the user is seriously thinking of quitting smoking 112, how soon the user smokes their first cigarette in the morning 114, how may times the user has quit smoking for at least 24 hours 116, and how many cigarettes the user smokes on an average day 118. In addition, the server can ask the user what kind of treatment was used during past quit attempts 120, whether or not the user would prefer to receive e-mail 122, the race or ethnic background of the user 124, the highest level of education that the user achieved 126, and the profession or trade of the user 128.

Software interface 110 also includes tailored information such as one or more quotes 130 that are tailored with regard to the user's stage of behavior modification. Also, software interface 110 includes tailored statistics, such as how much money the user can expect to save if they quit 132, days added to the user's life for quitting 134, and tips 136, which can be related to the user's stage of behavior modification.

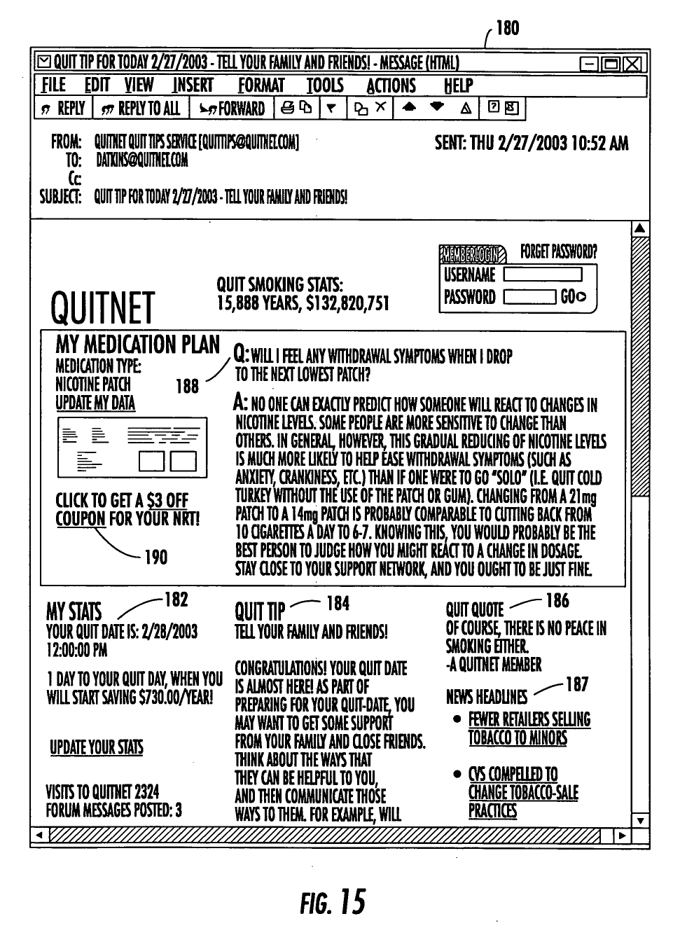

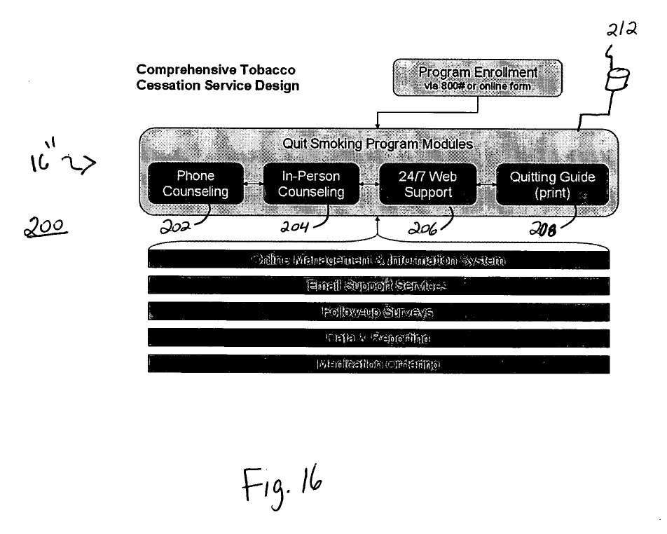

Software interface 140, FIG. 14, shows how the server can obtain observed user data. Software interface 140 can provide the user with options to use features of the system and track whether the user uses these features and how much if so. For example, software interface 140 includes a link 142 to a Quit Date Module to set a quit date, a link 144 to quitting tools to learn about smoking behavior, a link 146 to a quitting guide to obtain information, and a link 148 to a Medications Module. Software interface 140 can also include a link 150 to support forums, a link 152 to a buddy feature, a link 154 to “celebrate an anniversary of a quit date”, a link 156 to sending Q-mail to a friend, and a link 164 to “start a club”.

Software interface 140 also includes tailored information such as the feature My Next Steps 162 that provides suggested features from the My Next Steps Module. My next steps 162 shows the three next suggested steps as being Quit Date Wizard, My Profile and forums. The suggestions provided by My Next Steps 162 are frequently updated and re-tailored in an iterative process of obtaining and evaluating the observed user data and user supplied data. Interface 140 can also include information such as a user profile 164, a calendar 166, a journal 168, and user rewards 170.

Additionally, software interface 140 can include tab 161 for an expert support page that has information or a link for a user to obtain expert advice, such as by an expert counselor over the network, about the desired behavior modification. If a user contacts a counselor over the network, the counselor preferably has access to the user's observed user data and user supplied data to provide a tailored opinion and/or tailored suggestions to the user with regard to the desired behavior modification.

The server can also provide tailored information and/or suggestions to a user based on user supplied data and observed user data through an e-mail 180 to a user. E-mail 180 includes tailored information such as statistics 182, a “Quit Tip” 184, a quote 186 related to the behavior modification, news headlines 187, a frequent question and answer 188, and promotional information 190 relating to the behavior modification. The tailored information 182-190 and software interface 180 can include hypertext links to allow the user to obtain further information from the server if the user desires further information. The server can also obtain additional observed user data when a user selects one of the hypertext links in e-mail 180 related to tailored information 182-190.

One skilled in the art would recognize that this system can be applied to additional behavior modifications including, but not limited to, weight loss, alcohol and drug dependency and substance abuse through programs that may be stage-based, as illustrated in the example of smoking cessation, or non-stage based, where user-supplied and observed user data are evaluated along a continuum of change as the user progresses towards a long term goal such as weight reduction.

The methods of the present invention can be performed with a server or computer and computer software installed thereon that has instructions to perform the steps of the invention. Alternatively, methods of the present invention can be performed with equipment that has installed hardware or firmware having instructions to perform the steps of the invention. Software used with embodiments of the present invention can be stored on computer readable medium for storing data, such as, for example, but not limited to, floppy disks, magnetic tape, zip disks, hard drives, CD-ROM, optical disks, RAM, ROM, PROM or a combination of these.

In another embodiment of the invention, system 200, FIG. 16, includes one or more information delivery networks 16″, e.g., phone support module 202, in-person counseling support module 204, web support module 206, printed quitting guide module 208, and database 212. Web Support module 206 may include monitoring, evaluation, and presentation engines such as those described above for server 12, FIG. 2.

System 200 uses each of cessation modules 202-208 and the services associated therewith as an information delivery network to deliver tailored information to a user. For example, phone support module 202 provides tailored verbal communication from a counselor to the user over the telephone network. In-phone counseling module 204 allows a counselor to network with the user to provide tailored communication in-person. Web support module provides tailored information through the website of system 200. Quitting guide module 208 provides tailored written information, such as electronic media delivered to the user electronically over the Internet or through an e-mail communication network, or printed information delivered via postal mail network.

In operation, users of system 200 are provided with a comprehensive smoking cessation program by using the integrated management and counseling and reporting system to implement and report on all facets of their comprehensive program. In addition, system 200 uses Web Support module 206 to operate a custom version of its web service as a 24/7 support center for those who wish to use it.

The enrollment process and the tools needed to carry out each of these interventions are described as follows. Initial enrollment in the program, whether it is by phone or an online form, has the end result of creating a new record on database 212 of system 200. In order to create a member record a minimum set of questions must be completed. Gathering this data up-front will allow system 200 use other service components, e.g., email, follow-up surveys, data tracking and reporting, and make them available to each of cessation modules 202-208.

Customers of system 200 are able to manage their counselor accounts for the enrollment administrators, phone counselors and/or in-person counselors. This includes setting up the logins needed, adding or removing counselors, setting permissions, etc.

A preferred manner that potential users will be able to enroll into the program is by calling a toll free number and answering a set of questions. This enables the potential user to determine that they are eligible for the service, enter them into the system as a new enrollee and advise them of their options for support. The enrollment counselor will enter the details into the system via an enrollment page. Types of information that are collected may include: inter alia, employee ID or equivalent authentication data, first and last name, basic demographic information (e.g., age, race, gender, income), phone number, email address, staging questions (e.g., time to first cigarette, readiness to quit), and permission to contact them via email, support emails, follow-up surveys and notifications.

Preferably, the enrollment administrator will describe each of the modules and together with the new enrollee will determine the most appropriate intervention based on the needs and preferences of the individual. This will be noted on the call. If the individual chooses printed material as one of their interventions, their mailing address will be recorded. If they choose web, the enrollment administrator will confirm their email address and click a button that will trigger an email to the individual with instructions on how to access the web support module 206 of system 200 and register for support. If they choose phone support, the enrollment administrator will confirm their phone number and tentatively schedule their intake call, by recording the best time of day and/or day of the week to call. If they choose face-to-face, the enrollment administrator will let them know that they will be contacted soon for scheduling.

Rather than wait for the initial intake counselor phone call to be made, the intake questionnaire can be sent via email by the enrollment administrator to an enrollee or potential user. When initial enrollment is completed and a user has indicated that they are happy to be contacted via email, the enrollment administrator triggers an email that includes a link to an online intake form. If they choose not to complete it via email, the phone counselor completes it on their behalf during the initial intake call. This approach can minimize the time spent on what is traditionally a lengthy and expensive intake counselor call.

The same process for enrollment described above can also be offered more cost-effectively via the web, as a series of questions and information screens presented to the potential participant. The same authentication method to be used by the enrollment administrator may be implemented online.

If talking to an enrollment administrator over the phone is considered desirable or mandatory, an online enrollment form may be used as a pre-enrollment step that triggers an alert to the enrollment administrator to make an outbound call to complete the authentication process and confirm their choice of intervention.

Users that indicated phone counseling as their chosen intervention will have a record created in the phone counselor tool during enrollment. As soon as the enrollment has been completed, an email will be triggered to the phone counselors to alert them that there is a new enrollee awaiting an intake call.

The intake questionnaire preferably is customized by system 200 in consultation with each customer and other cessation experts. It consists of a series of questions that the counselor asks the users while they are on the phone. It includes elements needed to assess smoking history as well as how addicted the user is (e.g., staging questions, fagerstrom, quit date wizard, med wizard) and a confirmation of the best intervention method for the user. If the intake form has not been completed online by the user (see above for description), the counselor will complete it using an efficient interface including dropdowns, buttons and free entry fields while on the phone to the user.

Each user that completed enrollment will have a status (e.g., “awaiting intake”, “calls in progress”, “requested printed materials only”, and the like), and will be assigned to counselors before or during the initial call.

Counselors are preferable able to search database 212 at any time to locate: the users that are in the queue and waiting to be contacted, and their assigned users, if appropriate. The results of the search will be a list of users, that if clicked on, the counselor will be able to view the user information screen, as described below. They will also be able to view their call schedule for the day.

A user information screen displays all the data that has been gathered about the user that is considered to be important to the counselor in managing their calls, e.g., intake information, demographic information, call schedule, current quit date, and activity from other interventions. The activity from other interventions may include: if the user has attended face to face counseling and which one; if the user is registered for QuitNet and what features have they used, the results of their self-assessment questionnaires, has the user set a med plan, and the like; and if the user requested printed material and whether it has it been sent out. It is possible to restrict some content to only be viewed by the assigned counselor, if privacy is considered important.

Counselors will be able to enter future calls into the tool as well as modify existing calls that have already been scheduled. To schedule a new call, the relevant call in the protocol will be able to be selected and a time and date assigned. Calls added will be given a status that will enable counselors to manage them. Future calls will be flagged as having a status of “Call Pending”. Once a call is completed, its status can be changed to “Call Completed”, or if it is missed, “Call missed”. If the schedule changes for some reason, an email can be triggered to the user that alerts them to the new schedule. A reminder email will be automatically sent to the user 24 hours before each scheduled call. This will reinforce the call in the mind of the user and will reduce the risk that the call will be missed.

For each call in their schedule, counselors will be able to access and complete a checklist of topics to be discussed. In addition, fields are listed that need to be updated or confirmed, for example “Is this still your Quit Date?” and “Is this still your Med Plan?” A free text field is preferably available for notes

The phone counselor, after each call, is able to trigger an email to the user to thank them for participating in the call. The user is able to include special content relevant to the topics discussed on the call as well as additional encouraging messaging relevant to the stage of their quit.

All actions taken by each counselor within the tool are logged against the user record for tracking purposes. This enables the history of actions to be reviewed, if needed.

The counselors conducting the face to face counseling are able to log into an online interface from anywhere that there is Internet access and make a record of the attendees of each group or individual session. The screens are similar to the ones described for the phone counselors.

The face to face counselors are able to enter a schedule of sessions into the online tool. There are several ways in which this information can be used by system 200: to enable the face to face counselors to keep a calendar of upcoming events, to email as a reminder to the users that are signed up for face to face counseling, to use for referrals between modules, as discussed below.

The face to face counselor, after each call, is able to trigger an email to the user to thank them for participating in the session. The user is able to include special content relevant to the topics discussed in the session, as well as additional encouraging messaging relevant to the stage of their quit.

After enrollment, the user will be sent instructions via on how to access and register for the website of system 200. Alternatively, if the user chooses to enroll via a web page and a call is not needed with an intake counselor, they can proceed directly to the registration process.

Registrants have access to all of the features of system 200, which may include: inter alia, quitting tools, quit date wizard, calendar, journal, printable certificates, expert support, self-assessment questionnaires, one-to-one counseling, expert FAQs, expert chat sessions, access to the expert forums, medication support, medication guide, medication wizard, medication FAQs, The SHOP (wizard, product information and access to NRT), Email Support, Support emails tailored to the stage of quit resources, online quitting guide, news headlines, local program database, the QuitNet community, forums, clubs, chat, buddies, testimonials, q-cards, and personal q-mail, which is an internal email service.

For customization of the website for system 200, a customer logo can appear on every page. A special content pages may be included to provide information about the phone and Face to Face counseling, and to enable cross-module referrals to take place. A custom welcome message appears at the end of registration on the site. An option will be available to add a community forum that can be accessed by this population only. If the members of the online intervention of system 200 are also signed up for phone counseling, they will be able to view a schedule of their upcoming calls within the “My Quit” page of the site.

System 200 manages the design and printing of the Quitting Guide, complete with a customer logo. An exemplary guide can be found at http://www.quitnet.com/library/guides/Quitnet/. The guide will contain additional material such as user testimonials with photos, FAQs and quit comics utilized on the website of system 200. Customers are able to order the guide on behalf of its users using the online system. All inventory may be transferred to a fulfillment house of Customer's choosing. The fulfillment house will have access to an online interface to receive orders and confirm their shipment.

Counselors will be able to identify users who are interested in receiving web and/or face to face support as part of their smoking cessation program. For example, counselors may have access to a schedule of face to face sessions that the counselors have submitted and be able to sign the users up for them. Counselors may also be able to trigger an email to users that describes the website of system 200 and include instructions on how to get to the site and register for web support. Counselors may also be able to order printed materials for an individual at anytime through the tool.

Face-to-face counselors are able to log into the system and trigger: Web Support: Counselors will be able to trigger an email to users describing the QuitNet website and including instructions on how to get to the site and sign up; printed material: Counselors will be able to order printed materials for an individual at anytime through the tool; and phone support: users will be able to flag the individual as wanting phone support, that will trigger an email to the intake counselors to make an outbound call.

Web users will be able to access a custom page on the website that provides information about the other modules and enables them to sign up for them by providing some additional information (e.g., best time to call for phone counseling, mailing address, for printed material and the like).

There will be instructions and a phone number within the written materials to instruct the reader on how they can sign up for phone, web or face-to-face support.

The intake counselors have the option to sign new enrollees up to receive email support, even if they are not planning to choose web as their intervention. This will enable them to receive weekly emails before they set a quit date, then weekly preparation emails and daily emails in and around their quit date. These emails will contain a testimonial, a comic, and a quit tip of the day. Having a quit date logged in the system will enable a special monthly Anniversary message to be sent out, to congratulate the user on hitting their important milestones.

Users will be able to sign up for support emails at any time, by the phone counselors, the intake administrators, the face-to-face counselors or by themselves, through the website of system 200.

An interface will be available for phone counselors, face-to-face counselors and users using the Website to place orders for NRT. Access will be made available to “Shop Wizard” and “Medication Wizard” of system 200 to help determine the best medication type and dosage for the user.

Order information may be transmitted electronically to a third party. Orders can be processed by a fulfillment partner. Exemplary product offerings includes the nicotine patch, gum, and lozenge, brand name or generic. Product is shipped to user's home at competitive prices, with the added benefit of Customer not having to incur the cost of holding inventory or fulfilling orders.

A standard survey is preferable sent after enrollment in the program to all enrollees in all modules. The times that the survey may be sent typically at 3, 6 and 12 months. The survey may consist of 11 questions that assess current smoking habits and abstinence. The survey will be sent via an email invitation. If the user has not provided an email address or indicated that they are willing to be contacted via email, or fails to complete the email survey, they will need to be contacted by phone. Counselors will be able to log into the tool and access a list of users that need to be contacted by phone. The survey will be available through the tool to complete on behalf of the user while they are on the phone.

Reporting is provided on a monthly basis by system 200, as an overall report, and broken down by module, preferably across all interventions. The report may include the following: number of enrollees into each intervention, demographics of enrollees, smoking history at enrollment, amount of contact overall (e.g. number of log-ins, number of calls completed, number of face to face sessions attended), contact via email (of enrollees that received reminders, schedules, follow ups and support emails), number of enrollees that complete the intervention, and the smoking status at follow-up for each module.

Those associated with system 200 will train customer's counselors on the use of each module (via conference call or face to face). In addition, written support materials will be provided, and QuitNet staff will be available to answer any questions that arise. Counselors will have access to a tool that enables them to browse through database 212 which includes information of Frequently Asked Questions relating to quitting and medications. All of these are subject coded, making it easy to find the resources they are looking for.

Counselors will also be able to browse through database 212 that includes information of local programs, if they want to offer additional interventions that may not be included in this program.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A method of delivering information over one or more information delivery networks, the method comprising:
a) monitoring the actions of a user on the one or more networks to obtain observed user data relating to a desired behavior modification;
b) obtaining user supplied data relating to the desired behavior modification;
c) evaluating the observed user data and the use supplied data to generate tailored information for progressing a user towards the desired behavior modification;
d) presenting the tailored information to the user over at least one of the networks; and
e) repeating steps a), b), c) and d) until the desired behavior modification is achieved.

2. The method of claim 1 in which the one or more information delivery networks includes the Internet.

3. The method of claim 2 in which the one or more information delivery networks include a network chosen from the group consisting of a telephone network, an email communication network, interpersonal communication with a counselor, and a postal mail network.

4. The method of claim 1 in which the tailored information includes print or electronic media.

5. The method of claim 1 in which the desired behavior modification includes the cessation of smoking.

6. The method of claim 1 further including determining if additional data is required from the user in order for the user to achieve the desired behavior modification.

7. The method of claim 6 further including obtaining the additional data from the user.

8. The method of claim 1 wherein said user action is selected from the group consisting of: an interaction with a online questionnaire, an interaction with a module to assist the user in the cessation of smoking, an interaction with a module to assist the user in selecting a date for the cessation of smoking, interacting with a module to provide the user with the ability to manage personal information, an interaction with a calendar module to provide the user with the ability to set dates and goals which relate to the quit date and the desired behavior modification, an interaction with a journal module that allows the user to record information related to the desired behavior modification, an interaction with a Medications Module, an interaction with a module relating to frequently asked questions, and an interaction with an online support community, and an interaction with one or more of a telephone network, an email communication network, interpersonal communication with a counselor and a postal mail network.

9. The method of claim 8 wherein said Medications Module suggests a medication profile to the user based upon said user observed data and said user supplied data.

10. The method of claim 1 wherein said action of the user includes an interaction with an online support community that is selected from the group consisting of: a discussion forum relating to discussion of specific issues associated with the desired behavior modification, a user initiated forum, interactive communication with community members via on-line chat, a buddy feature that tracks whether other known users are on-line at the same time as the user, a list of users who are celebrating a milestone in the desired behavior modification, e-mail for sending and receiving messages to and from others users on the system, and one or more of a telephone network, an email communication network, interpersonal communication with a counselor and a postal mail network.

11. The method of claim 1 wherein said user supplied data is selected from the group consisting of: a quit date, an age, a sex, a zip code, a type of dependency, a quantity of dependent substance used, and questionnaire answers.

12. The method of claim 1 wherein said user observed data includes how often the user has interacted with specific features.

13. The method of claim 1 further including providing a link to the user to enable the user to interact with a counselor over the one or more delivery networks.

14. The method of claim 10 further comprising providing the observed user data and the user supplied data over the one or more networks to the counselor such that the counselor can provide tailored information and suggestions to the user based upon the observed user data and the user supplied data.

15. A method of delivering information over one or more information delivery networks, the method comprising:
a) monitoring the actions of a user on the one or more networks to obtain observed user data relating to a cessation of smoking;
b) obtaining user supplied data relating to the cessation of smoking;
c) evaluating the observed user data and the use supplied data to generate tailored information and provide suggestions for an event, said tailored information and suggestions for progressing a user towards the cessation of smoking;
d) presenting the tailored information and suggestions to the user over at least one of the networks; and
e) repeating steps a), b), c) and d) until the cessation of smoking is achieved.

16. A system for delivering healthcare content to a user over a one or more information delivery networks, the system comprising:
an Internet support module for providing counseling support to the user over the Internet, the Internet support module including:
a monitoring engine for monitoring an event of a user on the network to obtain observed user data relating to the cessation of smoking, and to obtain user supplied data relating to the cessation of smoking; and
an evaluation engine responsive to the monitoring engine, said evaluation engine configured to evaluate the observed user data and the user supplied data to generate tailored information which progresses the user towards the cessation of smoking; and
a telephone counseling module for providing counseling support to the user over the telephone.

17. The system of claim 16 further including an in-person counseling module for providing counseling support to the user.

18. The system of claim 16 further including a quitting guide module for providing print media delivered to the user electronically or via postal mail.

19. The system of claim 16 further including a medications module for suggesting a medication to the user.

20. The system of claim 16 further including a Quit Date Module for assisting the user in selecting a quit date for the desired behavior modification program.

21. The system of claim 16 further including a Profile Module for providing the user with the ability to manage personal information.
